(19) United States
(12) Patent Application Publication
(10) Pub. No.: US 2008/0059989 A1
(43) Pub. Date: Mar. 6, 2008

(54) Methods and systems for providing media assets over a network

(76) Inventors: Dan O'Connor, Plaistow, NH (US); Mark Pascarella, Andover, MA (US); Patrick Donovan, Westford, MA (US); Jeremy McPherson, Lowell, MA (US)

Correspondence Address: ROPES & GRAY LLP;PATENT DOCKETING 39/41, ONE INTERNATIONAL PLACE, BOSTON, MA, 02110-2624, US

(21) Appl. No.: 11/894,659

(22) Filed: Aug. 20, 2007

Related U.S. Application Data
(63) Continuation of application No. 11/799,631, filed on May 1, 2007.
(63) Continuation-in-part of application No. 10/060,001, filed on Jan. 29, 2002.
Application No. 11/799,631 is a continuation-in-part of application No. 10/165,587, filed on Jun. 8, 2002.
(60) Provisional application No. 60/746,135, filed on May 1, 2006.
(60) Provisional application No. 60/872,736, filed on Dec. 4, 2006.
(60) Provisional application No. 60/264,868, filed on Jan. 29, 2001.
(60) Provisional application No. 60/336,602, filed on Dec. 3, 2001.
(60) Provisional application No. 60/304,570, filed on Jul. 11, 2001.
(60) Provisional application No. 60/336,602, filed on Dec. 3, 2001.
(60) Provisional application No. 60/304,570, filed on Jul. 11, 2001.
(60) Provisional application No. 60/297,204, filed on Jun. 8, 2001.
(60) Provisional application No. 60/352,788, filed on Nov. 28, 2001.

(51) Int. Cl. H04N 7/16

(52) U.S. Cl. 725/9

(57) ABSTRACT

The invention relates to methods and apparatus for providing media assets over a network. First metadata corresponding to a first video asset is generated. The first metadata includes text describing contents displayed when the first video asset is played and a pointer to a location within a video file that corresponds to the first video asset. The pointer includes at least two of a start location, an end location, and a duration. The first metadata is transmitted for receipt by a client system capable of playing the first video asset. The client system displays portions of the text of the first metadata to a user of the client system, and uses the pointer of the first metadata to facilitate requesting the first video asset from a video server for transmitting video assets over the network.

### CROSS-REFERENCE TO RELATED APPLICATIONS

This application claims the benefit of U.S. Provisional Patent Application No. 60/746,135 filed May 1, 2006 and entitled “System and Method for Delivering On-Demand Video Via the Internet” and U.S. Provisional Patent Application No. 60/872,736 filed Dec. 4, 2006 and entitled “Systems and Methods of Searching For and Presenting Video and Audio.”

This application is also continuation in part of U.S. application Ser. No. 10/060,001 (filed by James D. Logan et al. on Jan. 29, 2002) entitled “Audio and Video Program Recording, Editing and Playback Systems Using Metadata” and published as U.S. patent application Publication No. 2002-0120925 on Aug. 29, 2002, which claims the benefit of U.S. Provisional Patent Application No. 60/264,868 filed Jan. 29, 2001 and entitled “Broadcast Television and Radio Recording, Editing and Playback Systems Using Metadata,” U.S. Provisional Patent Application No. 60/336,602 filed Dec. 3, 2001 and entitled “Methods and Apparatus for Automatically Bookmarking Programming Content,” and U.S. Provisional Patent Application No. 60/304,570 filed Jul. 11, 2001 and entitled “Audio and Video Program Recording, Editing and Playback Systems Using Metadata.”

This application is also a continuation in part of and claims the benefit of U.S. application Ser. No. 10/165,587 filed by James D. Logan et al. on Jun. 8, 2002 entitled “Audio and Video Program Recording, Editing and Playback Systems Using Metadata” and published as U.S. patent application Publication No. 2003/0093790 A1 on May 15, 2003, which claims the benefit of U.S. Provisional Patent Application No. 60/336,602 filed Dec. 3, 2001 and entitled “Methods and Apparatus for Automatically Bookmarking Programming Content,” U.S. Provisional Patent Application No. 60/304,570 filed Jul. 11, 2001 and entitled “Audio and Video Program Recording, Editing and Playback Systems Using Metadata,” U.S. Provisional Patent Application No. 60/297,204 filed Jun. 8, 2001 and entitled “Methods and Apparatus for Navigating Time-shifted Television Programming,” and U.S. Provisional Patent Application No. 60/352,788 filed Nov. 28, 2001 and entitled “Methods and Apparatus for Distributing Segmented Television Programming.”

The disclosure of each of the foregoing applications is incorporated herein by reference.

### FIELD OF THE INVENTION

In general, the invention relates to the field of media playback, in particular, the invention relates to methods and systems for providing and navigating media assets over networks.

### BACKGROUND OF THE INVENTION

Accompanying the rising popularity of the Internet is the rising prevalence of media content, such as video and audio, available over the Internet. The ability to organize and deliver a large number of media assets for presentation to a user of the Internet impacts the user's ability to locate desired media assets and willingness to use the services offered. In particular, the user often would like access to information describing the contents of a media asset and at what point in the media asset the contents occur, and the ability to retrieve only the portions of media assets that are of interest. The user often would like to not only easily locate desired media assets, but also any related media assets. As such, a need remains for methods and systems for providing media assets over a network that organizes and parses the media assets in a way that improves the user's experience of the media assets.

### SUMMARY OF THE INVENTION

The invention relates to methods and apparatus for providing media assets over a network. According to one aspect of the invention, first metadata corresponding to a first video asset is generated. The first metadata includes text describing contents displayed when the first video asset is played and a pointer to a location within a video file that corresponds to the first video asset. The pointer includes at least two of a start location, an end location, and a duration. The first metadata is transmitted for receipt by a client system capable of playing the first video asset. The client system displays portions of the text of the first metadata to a user of the client system, and uses the pointer of the first metadata to facilitate requesting the first video asset from a video server for transmitting video assets over the network. Second metadata corresponding to a second video asset may be transmitted for receipt by the client system, where the second metadata is related to the first metadata. The client system may simultaneously display portions of the first metadata and portions of the second metadata to the user. In some embodiments, a playlist of metadata corresponding to video assets is formed, where metadata of the playlist are related. The playlist is transmitted for display by the client system.

In some embodiments, the first metadata is associated with at least one contextual group of a plurality of contextual groups. Metadata of a contextual group may be related. For example, the plurality of contextual groups may include at least one of music, sports, news, entertainment, most recent, most popular, top ten, a musical artist, and a musical genre. Contextual groups of the plurality of contextual groups may be organized according to a tree structure. A playlist of metadata, each associated with the same contextual group of the plurality of contextual groups, may be formed. The portions of the text of the first metadata displayed by the client system may be related to a first contextual group where the client system displays other metadata associated with the first contextual group simultaneously with the portions of the text of the first metadata. Second metadata corresponding to the first video asset may be generated, where the first metadata is associated with a first contextual group of the plurality of contextual groups and the second metadata is associated with a second contextual group of the plurality of contextual groups.

In some embodiments, a search request transmitted from the client system is received. The transmitting of the first metadata occurs in response to the receiving of the search request. A plurality of metadata is located based on the search request, where the plurality of metadata includes the first metadata and are related to the search request. To locate the first metadata, a metadata index may be queried according to the search request and a storage location at which the first metadata is stored may be received.

In some embodiments, the client system displays advertisements selected based at least in part on the first metadata. The first metadata may include advertisement instructions for facilitating transmittal of advertisements to the client system. The advertisement instructions may include instructions to not display an advertisement in conjunction with the first video asset or a designation for an advertisement type. Usage of metadata may be tracked to generate a metadata usage record.

According to another aspect of the invention, a system for providing video assets over a network includes a metadata generator and a metadata server. The metadata generator generates first metadata corresponding to a first video asset, where the first metadata includes text describing contents displayed when the first video asset is played and a pointer to a location within a video file that corresponds to the first video asset. The pointer includes at least two of a start location, an end location, and a duration. The metadata server transmits the first metadata for receipt by a client system capable of playing the first video asset. The client system displays portions of the text of the first metadata to a user of the client system. In response to the user indicating the first metadata, the client system uses the pointer of the first metadata to facilitate requesting the first video asset from a video server for transmitting video assets over the network.

### BRIEF DESCRIPTION OF THE DRAWINGS

The foregoing discussion will be understood more readily from the following detailed description of the invention with reference to the following drawings:

FIG. 1 depicts an illustrative system for providing media assets over a network;

FIG. 2 depicts an illustrative system capable of providing video to users via multiple platforms;

FIGS. 3A and 3B depict illustrative abstract representations of formats for video and metadata corresponding to the video;

FIG. 4 depicts an illustrative screenshot of a user interface for interacting with video; and

FIG. 5 depicts an illustrative abstract representation of a sequence of frames of an encoded video file.

### DESCRIPTION OF CERTAIN ILLUSTRATIVE EMBODIMENTS

To provide an overall understanding of the invention, certain illustrative embodiments will now be described, including apparatus and methods for providing a community network. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope hereof.

The invention includes methods and systems for providing media assets over a network. Media assets may include video, audio, and any other forms of multimedia that can be electronically transmitted and may take the form of electronic files formatted according to any formats appropriate to the network and the devices in communication with the network. Metadata corresponding to the media assets is generated and may include a pointer to a location of the media asset and text describing contents of the media asset. In some embodiments, metadata includes advertisement instructions for facilitating the display of advertisements. Metadata enhances the user experience of media content by facilitating delivery of desired media assets, which may include media assets requested by the user and media assets related to the requested media asset. Metadata may be used to organize, index, parse, locate, and deliver media assets. Metadata may be generated automatically or by a user, stored in a storage device that is publicly accessible over the network, transferred between various types of networks and/or different types of presentation devices, edited by other users, and filtered according to the context in which the metadata is being used. The following illustrative embodiments describe systems and methods for providing video assets. The inventions disclosed herein may also be used with other types of media content, such as audio or other electronic media.

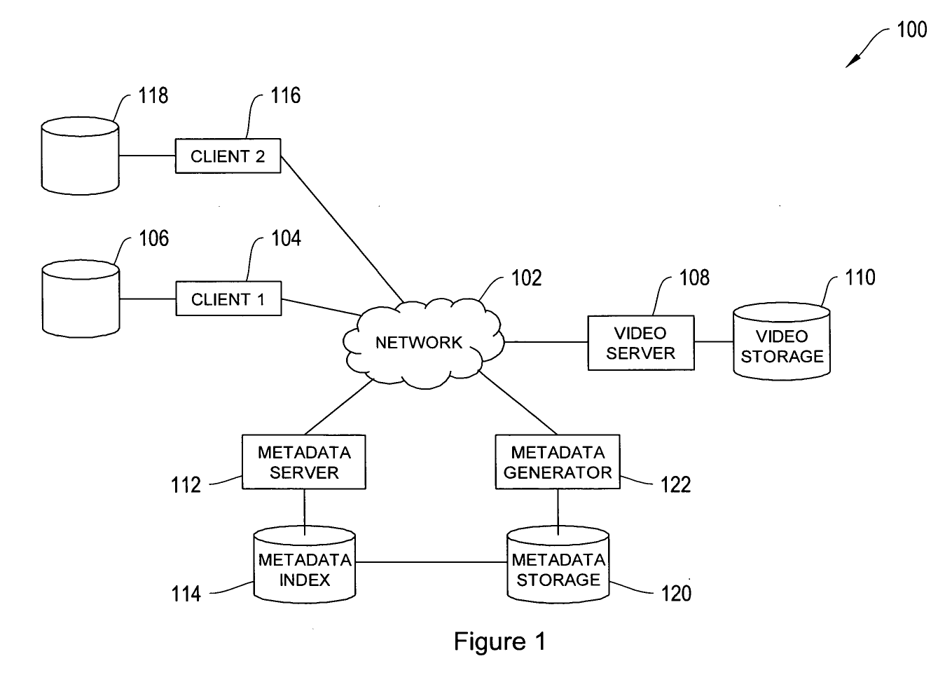

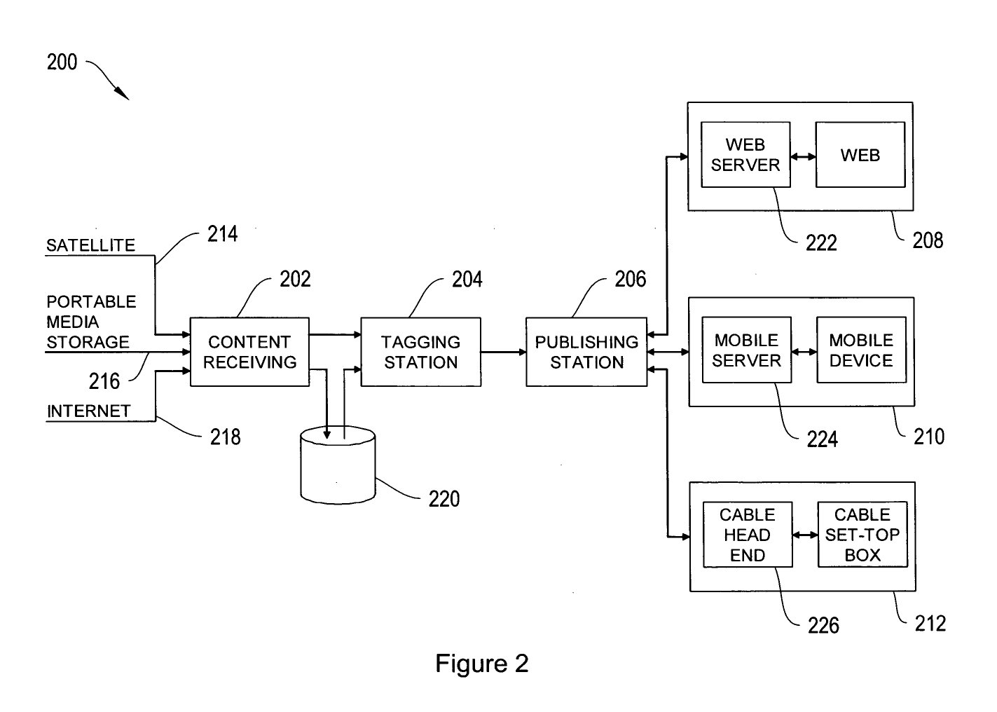

FIG. 1 depicts an illustrative system 100 for providing video over a network 102, such as the Internet. A first client device 104 and a second client device 116 may play videos to display contents of the videos to a user of the client device. A first user at a first client device 104 and a second user at a second client device 116 may each generate metadata that corresponds to videos, which may be either stored locally in storage 106 and 118, respectively, or available over the network, for example from a video server 108 in communication with storage 110 that stores video. Users, via corresponding client devices, may access a metadata generator 122 that provides a metadata-generating service. For example, the metadata generator 122 may be a server that delivers, for receipt by client devices, web interfaces capable of playing and navigating videos and receiving instructions for generating metadata. Videos processed by the metadata generator 122 may originate from a server available over the network 102, such as the video server 108 and/or from a video storage or receiving device in communication with the generator 122 outside of the network 102, as described below with respect to FIG. 2. The metadata generator 122 may be capable of automatically generating metadata for a video asset and may be accessed by users via client devices that are in communication with the metadata generator 122 outside of the network 102. Other users, though not depicted, may also be in communication with the network 102 and capable of generating metadata.

Metadata generated by users may be made available over the network 102 for use by other users and stored either at a client device, e.g., storage 106 and 118, or in storage 120 in communication with a metadata server 112 and/or the metadata generator 122. A web crawler may automatically browse the network 102 to create and maintain an index 114 of metadata corresponding to video available over the network 102, which may include user-generated metadata and metadata corresponding to video available from the video server 108. Alternatively, metadata index 114 may only index metadata stored at metadata storage 120. The metadata server 112 may receive requests over the network 102 for metadata that is stored at storage 120 and/or indexed by the metadata index 114 and, in response, transmit the requested metadata to client devices over the network 102. The client devices, such as the client devices 104 and 116, may use the requested metadata to retrieve video assets corresponding to the requested metadata, for example, from the video server 108. In particular, the client devices may request a video asset according to a pointer to a location for the video asset included in the corresponding metadata. A client device may request video assets in response to a user indicating metadata displayed on the client device. In some embodiments, the user may browse through metadata displayed on the client device and transmitted from the metadata server 112 without impacting the playback of video assets from the video server 108. Servers depicted in FIG. 1, such as the metadata server 112, the metadata generator 122, and the video server 108, are depicted as separate devices but may be available from the same server. Similarly, storage devices depicted in FIG. 1 are depicted as separate devices but may be the same server.

The metadata server 112 may include a search engine for processing search requests for video assets. The search requests may be initiated by users via client devices and may include search terms that are used to retrieve metadata related to the search terms from the metadata index 114. In some embodiments, the metadata index 114 returns a pointer to a location at which the related metadata is stored, for example, in the metadata storage 120.

The metadata server 112 may include or be in communication with an advertisement server (not shown) for delivering media ads such as graphics, audio, and video. The media ads may include hyperlinks that link to commerce websites that offer and sell products or services and/or informational websites for organizations, businesses, products, or services. The metadata server 112 may request advertisements from the advertisement server based on metadata and transmit the requested advertisements when transmitting the metadata for display. In some embodiments, the advertisement server delivers an advertisement related to portions of the metadata, such as key words or description. The advertisement may be displayed in conjunction with the video asset corresponding to the metadata. In particular, the advertisement may be simultaneously displayed, for example as a banner ad or graphic, or before or after the video asset is played, for example as a video advertisement. In some embodiments, the metadata corresponding to a video asset includes advertisement instructions that may be used by the advertisement server to select advertisements. The advertisement instructions may include text such as key words or phrases which may or may not be related to contents of the video asset, an indication of a preferred type of advertisement (e.g., video, hyperlinked, banner, etc.), and/or constraints that disallow certain advertisement types, advertisement content, or any advertisements at all from being displayed in conjunction with the video asset.

The metadata server 112 may organize available metadata, such as metadata stored in the metadata storage 120, to facilitate a user's ability to locate and discover video assets. In particular, the metadata server 112 may form a playlist of metadata corresponding to video assets that are related and transmit the playlist to a client device, such as the client devices 104 and 116, for display. The client device may display portions of the metadata, such as the text, in a menu which a user at the client device may use to navigate between the video assets. In particular, the client device may retrieve a video asset, using a pointer of metadata of the playlist, in response to the user indicating the metadata. Playlists may be formed automatically or based on input from a user. Metadata of a playlist may be a subset of metadata returned in response to a search request. The client device may also display multiple playlists at once. For example, multiple playlists may include metadata corresponding to the same video asset. When displaying that video asset, the client device may also display metadata corresponding to the next video asset from each of the multiple playlists to allow the user more options for where to navigate next.

The metadata server 112 may sort metadata into contextual groups using portions of the metadata that describe the contents of the video assets. The video assets may be presented to the user according to the contextual groups, allowing the user to browse for desired video assets by browsing contextual groups. Generally, the metadata associated with a contextual group are related. Metadata for a video asset may be associated with more than one contextual group. Contextual groups may be organized according to a tree structure, namely a structure where some groups are subsets of other groups. For example, video assets may be associated with at least one of the following contextual groups: news, music, sports, and entertainment. Each contextual group may be further parsed into subgroups, which may be subsets of one another, according to, for example, the type of sport or news item or genre of music or entertainment; a country, city, or other regional area; an artist, player, entertainer, or other person featured in the video asset; league, team, studio, producer, or recording company; a time associated with the events depicted in the video asset (e.g., classics, most recent, a specific year), and popularity level of the video asset as measured over a predetermined period of time (e.g. top ten news stories or top 5 music videos). Metadata may be automatically associated with a contextual group by the metadata server 112, or a user may instruct the metadata server 112 with which contextual groups to associate metadata. The metadata server 112 may form a playlist comprising metadata associated with a contextual group. The client device may display portions of the metadata that are related to a contextual group. In some embodiments, the metadata server 112 filters the metadata associated with a video asset based on a contextual group, for example when forming a playlist of the contextual group, and transmits to the client device for display the filtered metadata.

The metadata server 112 may track usage of metadata to generate a metadata usage record. In particular, the metadata server 112 may record information relating to requests for and transmittal of metadata including search requests, requests for and transmittal of contextual groups, and requests for and transmittal of playlists. When a video asset, which may be an advertisement video asset, is played, the metadata server 112 may record if the video asset automatically played, e.g., as the next item in a playlist, or if the user indicated the metadata corresponding to the video asset; identification information for the video asset; contextual group; date, start time, and stop time; the next action by the user, and the display mode (e.g., full screen or regular screen). The metadata server 112 may record user information including username, internet protocol address, location, inbound link (i.e., the website from which the user arrived), contextual groups browsed, time spent interacting with the metadata server 112 including start and end times.

In one embodiment, metadata is stored in at least two different formats. One format is a relational database, such as an SQL database, to which metadata may be written when generated. The relational database may be include tables organized by user and include, for each user, information such as user contact information, password, and videos tagged by the user and accompanying metadata. Metadata from the relational database may be exported periodically as an XML file to a flat file database, such as an XML file. The flat file database may be read, searched, or index, e.g. by an information retrieval application programming interface such as Lucene. Multiple copies of databases may each be stored with corresponding metadata servers, similar to the metadata server 112, at different colocation facilities that are synchronized.

FIG. 2 depicts an illustrative system 200 that is capable of providing video to users via multiple platforms. The system 200 receives video content via a content receiving system 202 that transmits the video content to a tagging station 204, which may be similar to the metadata generator 122 of FIG. 1 and is capable of generating metadata that corresponds to the video content to enhance a user's experience of the video content. A publishing station 206 prepares the video content and corresponding metadata for transmission to a platform, where the preparation performed by the publishing station 206 may vary according to the type of platform. FIG. 2 depicts three exemplary types of platforms: the Internet 208, a wireless device 210 and a cable television system 212.

The content receiving system 202 may receive video content via a variety of methods. For example, video content may be received via satellite 214, imported using some form of portable media storage 216 such as a DVD or CD, or downloaded from or transferred over the Internet 218, for example by using FTP (file transfer protocol). Video content broadcast via satellite 214 may be received by a satellite dish in communication with a satellite receiver or set-top box. A server may track when and from what source video content arrived and where the video content is located in storage. Portable media storage 216 may be acquired from a content provider and inserted into an appropriate playing device to access and store its video content. A user may enter information about each file such as information about its contents. The content receiving system 202 may receive a signal that indicates that a website monitored by the system 200 has been updated. In response, the content receiving system 202 may acquire the updated information using FTP.

Video content may include broadcast content, entertainment, news, weather, sports, music, music videos, television shows, and/or movies. Exemplary media formats include MPEG standards, Flash Video, Real Media, Real Audio, Audio Video Interleave, Windows Media Video, Windows Media Audio, Quicktime formats, and any other digital media format. After being receiving by the content receiving system 202, video content may be stored in storage 220, such as Network-Attached Storage (NAS) or directly transmitted to the tagging station 204 without being locally stored. Stored content may be periodically transmitted to the tagging station 204. For example, news content received by the content receiving system 202 may be stored, and every 34 hours the news content that has been received over the past 34 hours may be transferred from storage 220 to the tagging station 204 for processing.

The tagging station 204 processes video to generate metadata that corresponds to the video. The metadata may enhance an end user's experience of video content by describing a video, providing markers or pointers for navigating or identifying points or segments within a video, or generating playlists of video assets (e.g., videos or video segments). In one embodiment, metadata identifies segments of a video file that may aid a user to locate and/or navigate to a particular segment within the video file. Metadata may include the location and description of the contents of a segment within a video file. The location of a segment may be identified by a start point of the segment and a size of the segment, where the start point may be a byte offset of an electronic file or a time offset from the beginning of the video, and the size may be a length of time or the number of bytes within the segment. In addition, the location of the segment may be identified by an end point of the segment. The contents of video assets, such as videos or video segments, may be described through text, such as a segment or video name, a description of the segment or video, tags such as keywords or short phrases associated with the contents. Metadata may also include information that helps a presentation device decode a compressed video file. For example, metadata may include the location of the I-frames or key frames within a video file necessary to decode the frames of a particular segment for playback. Metadata may also designate a frame that may be used as an image that represents the contents of a video asset, for example as a thumbnail image. The tagging station 204 may also generate playlists of video assets that may be transmitted to users for viewing, where the assets may be excerpts from a single received video file, for example highlights of a sports event, or excerpts from multiple received video files. Metadata may be stored as an XML (Extensible Markup Language) file separate from the corresponding video file and/or may be embedded in the video file itself. Metadata may be generated by a user using a software program on a personal computer or automatically by a processor configured to recognize particular segments of video.

The publishing station 206 processes and prepares the video files and metadata, including any segment identifiers or descriptions, for transmittal to various platforms. Video files may be converted to other formats that may depend on the platform. For example, video files stored in storage 220 or processed by the tagging station 204 may be formatted according to an MPEG standard, such as MPEG-2, which may be compatible with cable television 212. MPEG video may be converted to flash video for transmittal to the Internet 208 or 1 GP for transmittal to mobile devices 210.

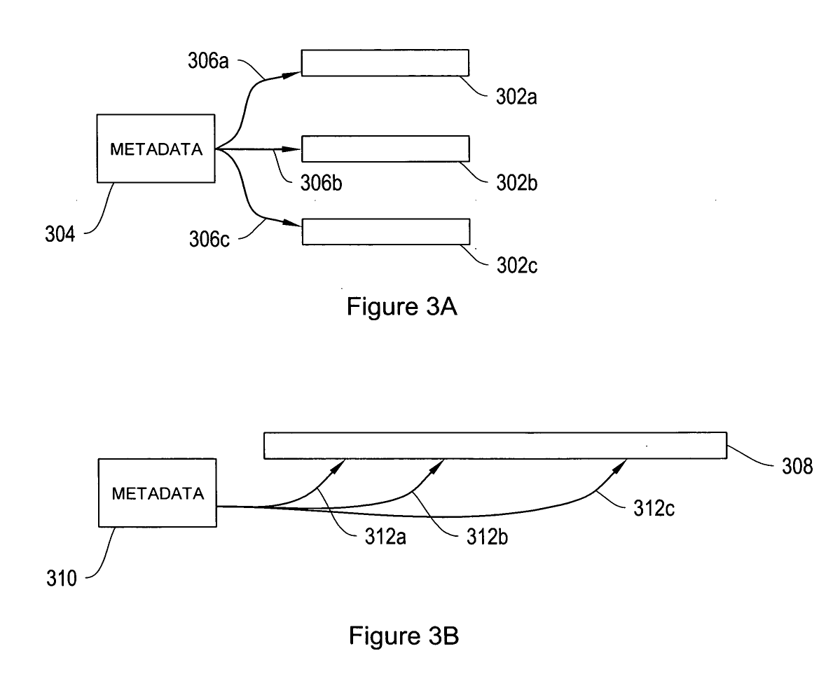

Video files may be converted to multiple video files, each corresponding to a different video asset, or may be merged to form one video file. FIG. 3A depicts an illustrative example of how video and metadata are organized for transmittal to the Internet 208 from the publishing station 206. Video assets are transmitted as separate files 302a, 302b, and 302c, with an accompanying playlist transmitted as metadata 304 that includes pointers 306a, 306b, and 306c to each file containing an asset in the playlist. FIG. 3B depicts an illustrative example of how video and metadata are organized for transmittal to a cable television system 212 from the publishing station 206. Video assets, that may originally have been received from separate files or sources, form one file 308, and are accompanied by a playlist transmitted as metadata 310 that includes pointers 312a, 312b, and 312c to separate points within the file 308 that each represent the start of a segment or asset. The publishing station 206 may also receive video and metadata organized in one form from one of the platforms 208, 210, and 212, for example that depicted in FIG. 3A, and re-organize the received video and metadata into a different form, for example that depicted in FIG. 3B, for transmittal to a different platform. Each type of platform 208, 210, or 212 has a server, namely a web server 222 (such as video server 108 depicted in FIG. 1), mobile server 224, or cable head end 226, respectively, that receives video and metadata from the publishing station 206 and can transmit the video and/or metadata to a presentation device in response to a request for the video, a video segment, and/or metadata.

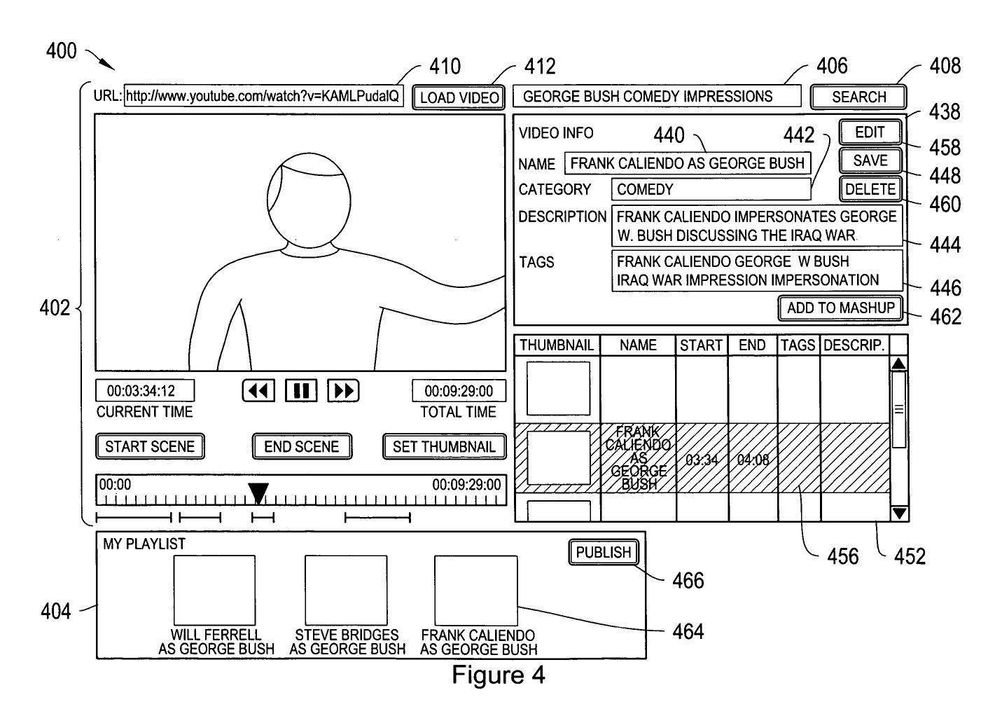

FIG. 4 depicts an illustrative screenshot 400 of a user interface for interacting with video. A tagging station 402 allows a user to generate metadata that designates segments of video available over a network such as the Internet. The user may add segments of video to an asset bucket 404 to form a playlist, where the segments may have been designated by the user and may have originally come from different sources. The user may also search for video assets available over the network by entering search terms into a search box 406 and clicking on a search button 408. A search engine uses entered search terms to locate video and video segments that have been indexed by a metadata index, similar to the metadata index 114 depicted in FIG. 1. For example, a user may enter the search terms “George Bush comedy impressions” to locate any video showing impersonations of President George W. Bush. The metadata index may include usernames of users who have generated metadata, allowing other users to search for video associated with a specific user. Playback systems capable of using the metadata generated by the tagging station 402 may be proprietary. Such playback systems and the tagging station 402 may be embedded in webpages, allowing videos to be viewed and modified at webpages other than those of a provider of the tagging station 402.

Using the tagging station 402, a user may enter the location, e.g. the uniform resource locator (URL), of a video into a URL box 410 and click a load video button 412 to retrieve the video for playback in a display area 414. The video may be an externally hosted Flash Video file or other digital media file, such as those available from YouTube, Metacafe, and Google Video. For example, a user may enter the URL for a video available from a video sharing website, such as http://www.youtube.com/watch?v=kAMIPudalQ, to load the video corresponding to that URL. The user may control playback via buttons such as rewind 416, fast forward 418, and play/pause 420 buttons. The point in the video that is currently playing in the display area 414 may be indicated by a pointer 422 within a progress bar 424 marked at equidistant intervals by tick marks 426. The total playing time 428 of the video and the current elapsed time 430 within the video, which corresponds to the location of the pointer 422 within the progress bar 424, may also be displayed.

To generate metadata that designates a segment within the video, a user may click a start scene button 432 when the display area 414 shows the start point of a desired segment and then an end scene button 434 when the display area 414 shows the end point of the desired segment. The metadata generated may then include a pointer to a point in the video file corresponding to the start point of the desired segment and a size of the portion of the video file corresponding to the desired segment. For example, a user viewing a video containing the comedian Frank Caliendo performing a variety of impressions may want to designate a segment of the video in which Frank Caliendo performs an impression of President George W. Bush. While playing the video, the user would click the start scene button 432 at the beginning of the Bush impression and the end scene button 434 at the end of the Bush impression. The metadata could then include either the start time of the desired segment relative to the beginning of the video, e.g., 03:34:12, or the byte offset within the video file that corresponds to the start of the desired segment and a number representing the number of bytes in the desired segment. The location within the video and length of a designated segment may be shown by a segment bar 436 placed relative to the progress bar 424 such that its endpoints align with the start and end points of the designated segment.

To generate metadata that describes a designated segment of the video, a user may enter into a video information area 438 information about the video segment such as a name 440 of the video segment, a category 442 that the video segment belongs to, a description 444 of the contents of the video segment, and tags 446, or key words or phrases, related to the contents of the video segment. To continue with the example above, the user could name the designated segment “Frank Caliendo as Pres. Bush” in the name box 440, assign it to the category “Comedy” in the category box 442, describe it as “Frank Caliendo impersonates President George W. Bush discussing the Iraq War” in the description box 444, and designate a set of tags 446 such as “Frank Caliendo George W Bush Iraq War impression impersonation.” A search engine may index the video segment according to any text entered in the video information area 438 and which field, e.g. name 440 or category 442, the text is associated with. A frame within the segment may be designated as representative of the contents of the segment by clicking a set thumbnail button 450 when the display area 414 shows the representative frame. A reduced-size version of the representative frame, e.g. a thumbnail image such as a 240×200 pixel JPEG file, may then be saved as part of the metadata.

When finished with entering information, the user may click on a save button 448 to save the metadata generated, without necessarily saving a copy of the video or video segment. Metadata allows a user to save, upload, download, and/or transmit video segments by generating pointers to and information about the video file, and without having to transmit the video file itself. As generally metadata files are much smaller than video files, metadata can be transmitted much faster and use much less storage space than the corresponding video. The newly saved metadata may appear in a segment table 452 that lists information about designated segments, including a thumbnail image 454 of the representative frames designated using the set thumbnail button 450. A user may highlight one of the segments in the segment table 452 with a highlight bar 456 by clicking on it, which may also load the highlighted segment into the tagging station 402. If the user would like to change any of the metadata for the highlighted segment, including its start or end points or any descriptive information, the user may click on an edit button 458. The user may also delete the highlighted segment by clicking on a delete button 460. The user may also add the highlighted segment to a playlist by clicking on an add to mash-up button 462 which adds the thumbnail corresponding to the highlighted segment 464 to the asset bucket 404. To continue with the example above, the user may want to create a playlist of different comedians performing impressions of President George W. Bush. When finished adding segments to a playlist, the user may click on a publish button 466 that will generate a video file containing all the segments of the playlist in the order indicated by the user. In addition, clicking the publish button 466 may open a video editing program that allows the user to add video effects to the video file, such as types of scene changes between segments and opening or closing segments.

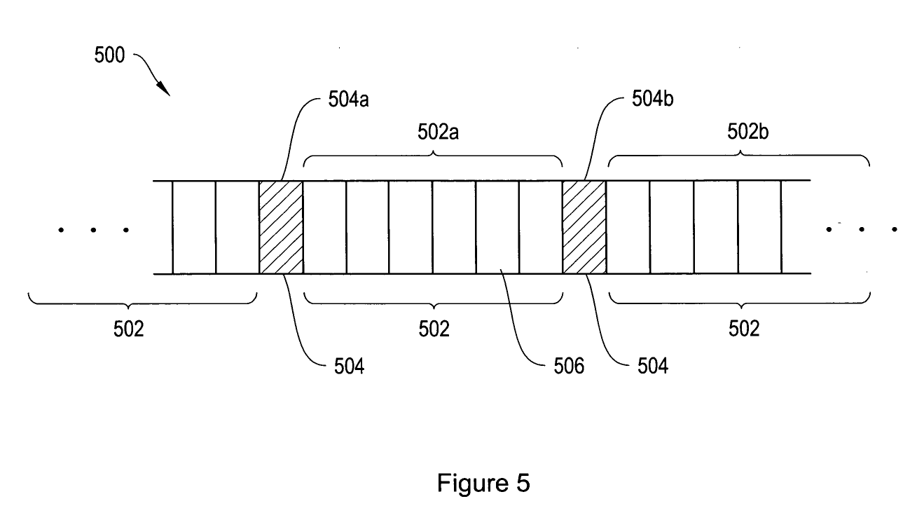

Metadata generated and saved by the user may be transmitted to or available to other users over the network and may be indexed by the metadata index of the search engine corresponding to the search button 408. When another user views or receives metadata and indicates a desire to watch the segment corresponding to the viewed metadata, a playback system for the other user may retrieve just that portion of a video file necessary for the display of the segment corresponding to the viewed metadata. For example, the hypertext transfer protocol (http) for the Internet is capable of transmitting a portion of a file as opposed to the entire file. Downloading just a portion of a video file decreases the amount of time a user must wait for the playback to begin. In cases where the video file is compressed, the playback system may locate the key frame (or I-frame or intraframe) necessary for decoding the start point of the segment and download the portion of the video file starting either at that key frame or the earliest frame of the segment, whichever is earlier in the video file. FIG. 5 depicts an illustrative abstract representation 500 of a sequence of frames of an encoded video file. In one embodiment, the video file is compressed such that each non-key frame 502 relies on the nearest key frame 504 that precedes it. In particular, non-key frames 502a depend on key frame 504a and similarly non-key frames 502b depend on key frame 504b. To decode a segment that starts at frame 506, for example, a playback system would download a portion of the video file starting at key frame 504a. The location of the necessary key frames and/or the point in a video file at which to start downloading may be saved as part of the metadata corresponding to a video segment.

The user may also during playback of a video or video segment mark a point in the video and send the marked point to a second user so that the second user may view the video beginning at the marked point. Metadata representing a marked point may include the location of the video file and a pointer to the marked point, e.g. a time offset relative to the beginning of the video or a byte offset within the video file. The marked point, or any other metadata, may be received on a device of a different platform than that of the first user. For example, with reference to FIG. 2, the first user may mark a point in a video playing on a computer connected to the Internet, such as the Internet 208, then transmit the marked point via the publishing station 206 to a friend who receives and plays back the video, starting at the marked point, on a mobile phone, such as the wireless device 210. Marked points or other metadata may also be sent between devices belonging to the same user. For example, a user may designate segments and create playlists on a computer connected to the Internet, to take advantage of the user interface offered by such a device, and send playlists and marked points indicating where the user left off watching a video to a mobile device, which is generally more portable than a computer.

In general, a device on a platform 208, 210 or 212 depicted in FIG. 2 may be in communication with a network similar to the network 102 depicted in FIG. 3 to allow users in communication with the network 102 access to video and metadata generated by the system 200 of FIG. 2 and to transmit video and metadata across platforms. The user interface depicted in FIG. 4 may be used on any of the platforms 208, 210, and 212 of FIG. 2. In addition, simplified versions of the user interface, for example a user interface that allows only playback and navigation of playlists or marked points, may be used on platforms having either a small display area, e.g. a portable media player or mobile phone, or tools for interacting with the user interface with relatively limited capabilities, e.g., a television remote.

Applicants consider all operable combinations of the embodiments disclosed herein to be patentable subject matter. The invention may be embodied in other specific forms without departing from the spirit or essential characteristics thereof. The forgoing embodiments are therefore to be considered in all respects illustrative, rather than limiting of the invention.

What is claimed is:

1. A method for providing video assets over a network, comprising
generating first metadata corresponding to a first video asset, the first metadata comprising
text describing contents displayed when the first video asset is played, and
a pointer to a location within a video file that corresponds to the first video asset, the pointer comprising at least two of a start location, an end location, and a duration, and
transmitting the first metadata for receipt by a client system capable of playing the first video asset, wherein
the client system displays portions of the text of the first metadata to a user of the client system, and
in response to the user indicating the first metadata, the client system uses the pointer of the first metadata to facilitate requesting the first video asset from a video server for transmitting video assets over the network.

2. The method of claim 1, comprising transmitting second metadata corresponding to a second video asset for receipt by the client system, wherein the second metadata is related to the first metadata.

3. The method of claim 2, wherein the client system simultaneously displays portions of the first metadata and portions of the second metadata to the user.

4. The method of claim 1, comprising associating the first metadata with at least one contextual group of a plurality of contextual groups.

5. The method of claim 4, wherein contextual groups of the plurality of contextual groups are organized according to a tree structure.

6. The method of claim 4, comprising forming a playlist of metadata each associated with the same contextual group of the plurality of contextual groups.

7. The method of claim 4, wherein metadata associated with a contextual group are related.

8. The method of claim 7, wherein the plurality of contextual groups includes at least one of music, sports, news, entertainment, most recent, most popular, top ten, a musical artist, and a musical genre.

9. The method of claim 4, wherein
the portions of the text of the first metadata displayed by the client system are related to a first contextual group of the at least one contextual group, and
the client system displays other metadata associated with the first contextual group simultaneously with the portions of the text of the first metadata.

10. The method of claim 4, comprising generating second metadata corresponding to the first video asset, wherein the first metadata is associated with a first contextual group of the plurality of contextual groups and the second metadata is associated with a second contextual group of the plurality of contextual groups.

11. The method of claim 1, comprising forming a playlist of metadata corresponding to video assets, wherein metadata of the playlist are related, and transmitting the playlist for display by the client system.

12. The method of claim 1, comprising
receiving a search request transmitted from the client system, wherein the transmitting the first metadata occurs in response to the receiving the search request, and
locating a plurality of metadata based on the search request, wherein the plurality of metadata includes the first metadata and are related to the search request.

13. The method of claim 12, wherein the locating the first metadata comprises
querying a metadata index according to the search request, and
receiving a storage location within a metadata store at which the first metadata is stored.

14. The method of claim 1, wherein the client system displays advertisements selected based at least in part on the first metadata.

15. The method of claim 1, wherein the first metadata comprises advertisement instructions for facilitating transmittal of advertisements to the client system.

16. The method of claim 15, wherein the advertisement instructions comprise instructions to not display an advertisement in conjunction with the first video asset.

17. The method of claim 15, wherein the advertisement instructions comprise a designation for an advertisement type.

18. The method of claim 1, comprising tracking usage of metadata to generate a metadata usage record.

19. A system for providing video assets over a network, comprising
a metadata generator for generating first metadata corresponding to a first video asset, the first metadata comprising
text describing contents displayed when the first video asset is played, and
a pointer to a location within a video file that corresponds to the first video asset, the pointer comprising at least two of a start location, an end location, and a duration, and
a metadata server for transmitting the first metadata for receipt by a client system capable of playing the first video asset, wherein
the client system displays portions of the text of the first metadata to a user of the client system, and
in response to the user indicating the first metadata, the client system uses the pointer of the first metadata to facilitate requesting the first video asset from a video server for transmitting video assets over the network.

20. The system of claim 19, wherein the metadata server transmits second metadata corresponding to a second video asset for receipt by the client system, wherein the second metadata is related to the first metadata.

21. The system of claim 20, wherein the client system simultaneously displays portions of the first metadata and portions of the second metadata to the user.

22. The system of claim 1, wherein the metadata server associates the first metadata with at least one contextual group of a plurality of contextual groups.

23. The system of claim 22, wherein contextual groups of the plurality of contextual groups are organized according to a tree structure.

24. The system of claim 22, wherein the metadata server forms a playlist of metadata each associated with the same contextual group of the plurality of contextual groups.

25. The system of claim 22, wherein metadata associated with a contextual group are related.

26. The system of claim 25, wherein the plurality of contextual groups includes at least one of music, sports, news, entertainment, most recent, most popular, top ten, a musical artist, and a musical genre.

27. The system of claim 22, wherein
the portions of the text of the first metadata displayed by the client system are related to a first contextual group of the at least one contextual group, and
the client system displays other metadata of the first contextual group simultaneously with the portions of the text of the first metadata.

28. The system of claim 22, wherein the metadata server generates second metadata corresponding to the first video asset, wherein the first metadata is associated with a first contextual group of the plurality of contextual groups and the second metadata is associated with a second contextual group of the plurality of contextual groups.

29. The system of claim 1, wherein the metadata server forms a playlist of metadata corresponding to video assets, wherein metadata of the playlist are related, and transmitting the playlist for display by the client system.

30. The system of claim 1, wherein the metadata server
receives a search request transmitted from the client system, wherein the transmitting the first metadata occurs in response to the receiving the search request, and
locates a plurality of metadata based on the search request, wherein the plurality of metadata includes the first metadata and are related to the search request.

31. The system of claim 30, wherein the metadata server
queries a metadata index according to the search request, and
receives a storage location within a metadata store at which the first metadata is stored.

32. The system of claim 19, wherein the client system displays advertisements selected based at least in part on the first metadata.

33. The system of claim 19, wherein the first metadata comprises advertisement instructions for facilitating transmittal of advertisements to the client system.

34. The system of claim 33, wherein the advertisement instructions comprise instructions to not display an advertisement in conjunction with the first video asset.

35. The system of claim 33, wherein the advertisement instructions comprise
an advertisement location within the video file that represents at least one of a beginning point, a midpoint, and an endpoint of the first video asset, and
instructions to play a video advertisement at the advertisement location.

36. The system of claim 19, wherein the metadata server tracks usage of metadata to generate a metadata usage record.
